(19) United States
(12) Patent Application Publication
(10) Pub. No.: US 2009/0077841 A1
(43) Pub. Date: Mar. 26, 2009

(54) HIGH PRODUCT DENSITY INTERACTIVE ROTATING KIOSK WITH VIRTUAL TRACKING ANIMATION USER INTERFACE AND INTEGRATED INTELLIGENT LIGHTING CONTROLLER

(76) Inventors: Nghi (Roger) Hoai Ngo, Kansas City, MO (US); David Christopher Onkels, Keller, TX (US); Steven Bryan Owens, Kansas City, MO (US); John Jason Pieschl, Wichita, KS (US); Barrett Clark Prelogar, Leawood, KS (US); Christopher Lee Vogel, Kansas City, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/200,840

(22) Filed: Aug. 28, 2008

Related U.S. Application Data
(60) Provisional application No. 60/968,463, filed on Aug. 28, 2007.

(51) Int. Cl. G09F 11/00

(52) U.S. Cl. 40/1

(57) ABSTRACT

An apparatus and method to rotatably display a plurality of products having corresponding animation of the plurality of products via virtual tracking to enable user interaction with the plurality of products, such as selection of one or more of the plurality of products to gain more information about the one or more of the plurality of products and/or to compare one or more of the plurality of products with each other.

### CROSS-REFERENCE TO RELATED APPLICATIONS

This application claims priority to U.S. Provisional Patent Application Ser. No. 60/968,463, filed Aug. 28, 2007, titled HIGH PRODUCT DENSITY INTERACTIVE ROTATING KIOSK WITH VIRTUAL TRACKING ANIMATION USER INTERFACE AND INTEGRATED INTELLIGENT LIGHTING CONTROLLER, the disclosure of which is incorporated herein by reference in its entirety.

### BACKGROUND OF THE INVENTION

1. Field of the Invention

The present invention generally relates to product display and, more particularly, to an apparatus and method to rotatably display a plurality of products having corresponding animation of the plurality of products via virtual tracking to enable user interaction with the plurality of products.

2. Description of the Related Art

Electronic devices and components thereof have decreased in size considerably over the past few decades, which presents security issues for retail stores who are concerned with theft of the small electronic devices and are required to take security precautions. For example, such retail stores may place high-value electronic devices within glass-enclosed display cases.

Traditional glass display cases are deficient and severely hamper marketability of the electronic device because if the customer desired a more detailed inspection of the electronic device, the customer must seek a sales associate to unlock the display case to retrieve the electronic device. The sales associate must remain with the electronic device while the customer is handling it and the display case is unlocked. This is undesirable because the number of sales associates in the retail store is generally limited and other customers may be neglected while the sales associate is assisting with the electronic device and monitoring the unlocked display case. Further, during the handling of the electronic device, there is a possibility that the customer or sales associate may drop it. Still further, the sales associate may not be aware of all of the features of the electronic device or appreciate the differences between one electronic device and another, which is especially likely given the vast number of features possessed by electronic devices and the highly detailed features thereof that may be important to a particular customer, e.g., precise weight of the product, battery power, accessories, etc.

Other security precautions, such as video cameras and security guards, are expensive to employ and are also deficient.

Maximizing each square foot of the retail store is of the utmost importance because retail stores are typically located in high-traffic areas where real estate is at a premium. At odds with this consideration is that customers are generally inclined to visit retail stores with the best selection and widest variety of products. Retail stores are often forced to balance real estate costs with selection, which requires the retail store to select only a segment of available products for display within the retail store and on their shelves or within their display cases.

Glass cases provide standard illumination regardless of the product being displayed. Typically, the only adaptability of such lighting is the ability to be aimed.

Accordingly, there is a demand for an apparatus and method to securely store and display a plurality of products and provide a user-friendly interface that does not require assistance from a sales associate, whereby a user may select one product of the plurality of products to gain more information on the one product and/or compare the plurality of products with each other.

### SUMMARY OF THE INVENTION

The present general inventive concept provides an apparatus and method to rotatably display a plurality of products having a corresponding animation of the plurality of products via virtual tracking to provide user interaction with the plurality of products, such as selection of one or more of the plurality of products to gain more information about the one or more of the plurality of products and/or to compare one or more of the plurality of products with each other.

The present general inventive concept also allows for the display of a complete “product package” such that upon selecting a primary product for purchase, the user may observe the primary product along with all compatible accessories. Such a product package facilitates additional sales thereby increasing total sales volume and allows for creating marketing, such as providing purchase incentives and/or discounts to the user if the user purchases the primary product and one or more compatible accessories.

The present general inventive concept also reduces overhead because significantly fewer sales associates are required for demonstrating products and answering questions. Moreover, the present general inventive concept allows retail stores to operate in less space while displaying more products. The savings achieved from the lower overhead may be passed on to the customer.

The present general inventive concept also provides a controller to make various lighting effects available that may aid in marketing the products. For instance, intensity, colors, and hues from every spectrum of the rainbow may be programmed to change depending on the product displayed. The product may have features better demonstrated in a certain color. Lighting may be used to direct a user's attention to areas adjacent to the kiosk in use. For instance, another kiosk having products relevant to the kiosk in use, e.g., accessories, may illuminate depending on the product being displayed. Further, the lighting may change according to subject matter being displayed on the display screen. For instance, direct or ambient lighting may be lowered to heighten visibility of the display screen or draw a customer's attention toward the display screen. Lighting may also be changed to draw a customers attention to any area of the kiosk, such as but not limited to toward the display screen, the actual product, and/or buttons on the kiosk.

The foregoing and/or other aspects and advantages of the present general inventive concept may be achieved by providing a rotating product kiosk capable of storing a plurality of products.

The foregoing and/or other aspects and advantages of the present general inventive concept may be also achieved by providing an animation of one or more of the plurality of products so that one or more of an animated plurality of products corresponds to a one or more physical plurality of products.

The foregoing and/or other aspects and advantages of the present general inventive concept may be also achieved by displaying the one or more of the animated plurality of products on one or more display screens or the like.

The foregoing and/or other aspects and advantages of the present general inventive concept may be also achieved by displaying the one or more of the physical plurality of products within one or more kiosk windows, or the like.

The foregoing and/or other aspects and advantages of the present general inventive concept may also be achieved by providing virtual tracking to ensure that the one or more of the animated plurality of products corresponds to the one or more physical plurality of products.

The foregoing and/or other aspects and advantages of the present general inventive concept may also be achieved by providing virtual tracking to permit a user to select the one or more of the physical plurality of products so that a corresponding one or more of the animated plurality of products is displayed.

The foregoing and/or other aspects and advantages of the present general inventive concept may also be achieved by providing virtual tracking to provide user interaction with the plurality of products, such as but not limited to selection of one or more of the plurality of products to gain more information about the one or more of the plurality of products and/or to compare the one or more of the plurality of products with each other.

The foregoing and/or other aspects and advantages of the present general inventive concept may also be achieved by an apparatus to display a plurality of products thereon, the apparatus including a body having a user interface, a rotatable element that extends through the body to support a product thereon, a display that corresponds to the rotatable element, and an input screen to allow a user to select the product.

The foregoing and/or other aspects and advantages of the present general inventive concept may also be achieved by providing a system to enable a user to view and purchase at least one of a plurality of products, the system including providing a unit having a user interface and a rotatable element supporting a plurality of products thereon, displaying a virtual image of at least one of the plurality of products on a display element, permitting selection of at least one of the plurality of products via an input element to gain more information on the product, and permitting purchase of at least one of the plurality of products via the input element.

The virtual image of one of the plurality of products may be displayed based on an orientation of the rotatable element.

The user interface may be multilingual for interaction in languages such as English, Arabic, or the like.

The rotatable element may extend through the body and may be exposed on at least two sides thereof.

Additional aspect and advantages of the present general inventive concept will be set forth in part in the description which follows and, in part, will be obvious from the description, or may be learned by practice of the general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of the present general inventive concept illustrating a high product density interactive rotating kiosk according to an exemplary embodiment of the present general inventive concept.

FIG. 2 is a front elevational view of the present general inventive concept illustrating a high product density interactive rotating kiosk according to the exemplary embodiment of the present general inventive concept.

FIG. 3 is a side sectional view of the present general inventive concept illustrating a high product density interactive rotating kiosk according to the exemplary embodiment of the present general inventive concept.

FIG. 4 is a top plan view of the present general inventive concept illustrating a high product density interactive rotating kiosk according to the exemplary embodiment of the present general inventive concept.

FIG. 5 is a perspective view of the present general inventive concept illustrating a high product density interactive rotating kiosk according to the exemplary embodiment of the present general inventive concept.

FIG. 5A is a magnified perspective view of the present general inventive concept taken along A of FIG. 5 illustrating a high product density interactive rotating kiosk according to the exemplary embodiment of the present general inventive concept.

FIG. 5B is a magnified perspective view of the present general inventive concept taken along B of FIG. 5 illustrating a high product density interactive rotating kiosk according to the exemplary embodiment of the present general inventive concept.

FIG. 5C is a magnified perspective view of the present general inventive concept taken along C of FIG. 5 illustrating a high product density interactive rotating kiosk according to the exemplary embodiment of the present general inventive concept.

FIG. 6 is a perspective view of the present general inventive concept illustrating a high product density interactive rotating kiosk according to the exemplary embodiment of the present general inventive concept.

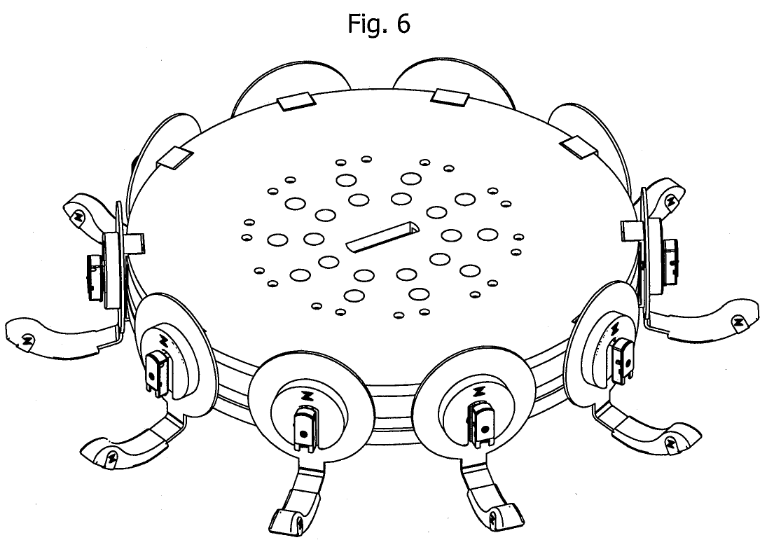

FIG. 7 is a perspective view of the present general inventive concept illustrating a high product density interactive rotating kiosk according to the exemplary embodiment of the present general inventive concept.

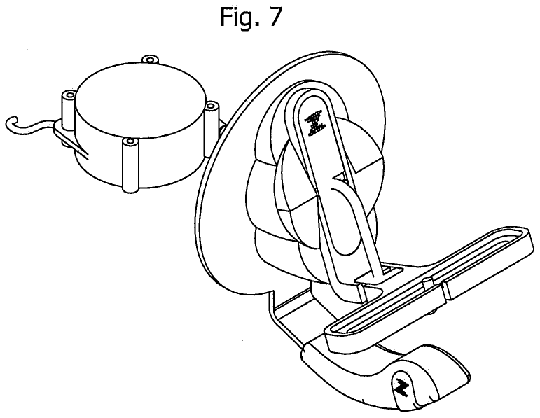

FIG. 8 is a perspective view of the present general inventive concept illustrating a plurality of high product density interactive rotating kiosk according to the exemplary embodiment of the present general inventive concept.

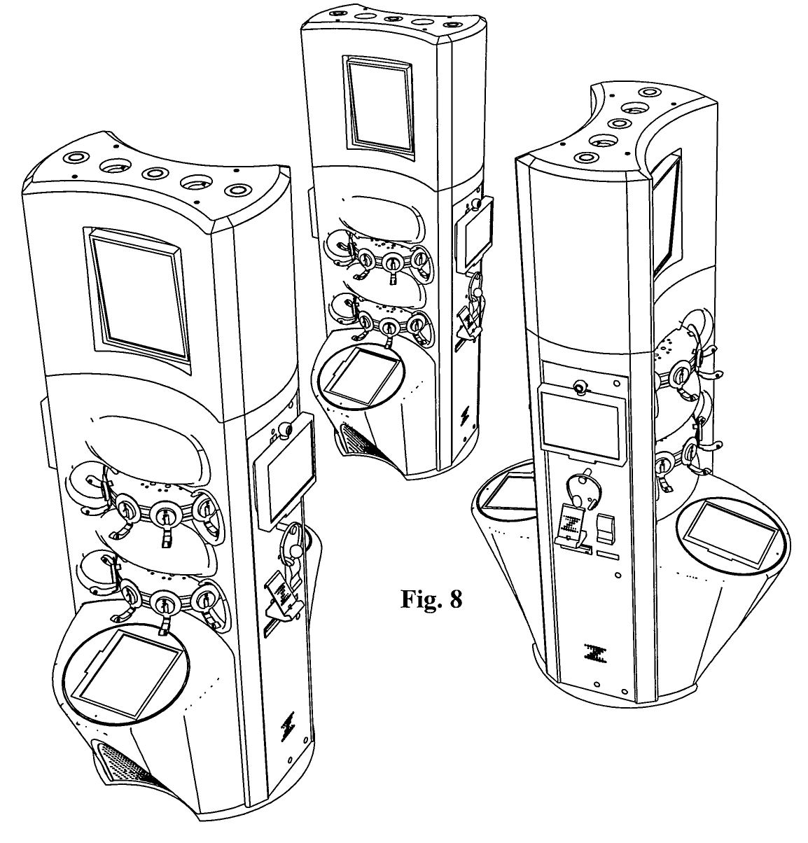

### DETAILED DESCRIPTION OF THE INVENTION

Reference will now be made in detail to the embodiments of the present general inventive concept, examples of which are illustrated in the accompanying drawings, wherein like reference numerals refer to like elements throughout. The embodiments are described below to explain the present general inventive concept by referring to the figures.

The present general inventive concept comprises a high product density interactive rotating kiosk apparatus and method.

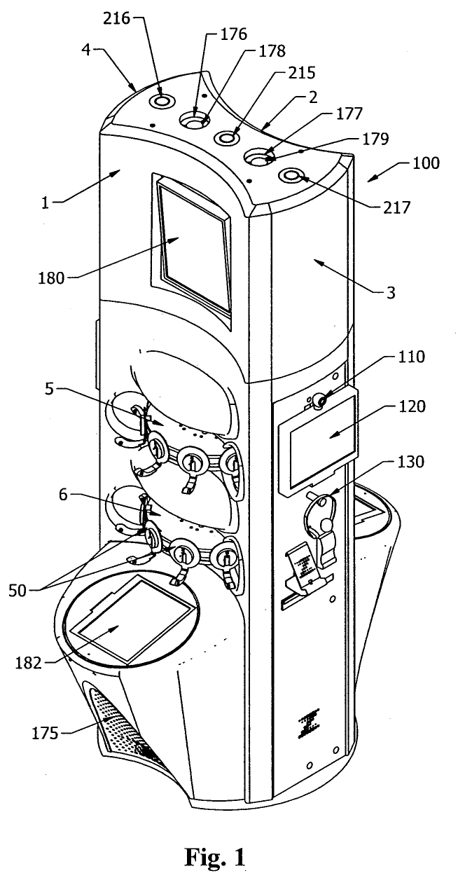

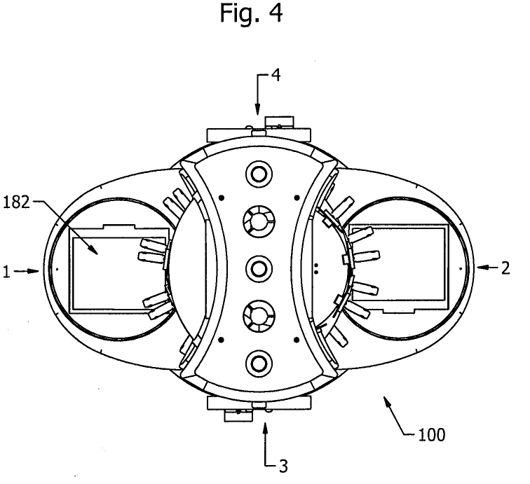

FIGS. 1-4 illustrate a kiosk body 100 of the present general inventive concept having a front and rear sides 1 and 2, and left and right sides 3 and 4. The front and rear sides 1 and 2 are substantially identical to each other except for exposed and unexposed portions that will be discussed in detail hereafter. The left and right sides 3 and 4 are identical to each other.

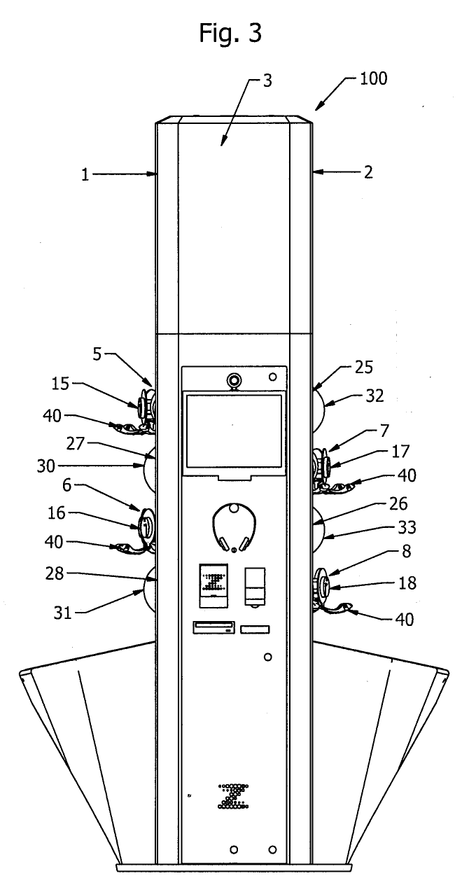

The kiosk body 100 has four wheels 5, 6, 7, and 8 (hereinafter “wheels 5-8”) that are stacked on top of each other and substantially contained within the kiosk body 100. Each wheel 5-8 extends slightly outward on both the front side 1 and the rear side 2, as illustrated in FIG. 3. Each of the wheels 5-8 have an exposed sides and an unexposed side. Specifically, the wheel 5 has an exposed side 15 on the front side 1, and a unexposed side 25 on the rear side 2. The wheel 6 has an exposed side 16 on the front side 1, and an unexposed side 26 on the rear side 2. The wheel 7 has an exposed side 17 on the rear side 2, and an unexposed side 27 on the front side 1. The wheel 8 has an exposed side 18 on the rear side 2, and an unexposed side 28 on the front side 2.

The unexposed sides 25, 26, 27, and 28 are respectively located behind transparent enclosures 30, 31, 32, and 33 that are made of a transparent or translucent material such as glass or plastic. The wheels 5-8 are designed to be manually rotated by a user although it is foreseen that the rotation may be automatically controlled by a computer or push-button (not illustrated). For example, the user standing at the front side 1 may selectively rotate wheels 5 and 6 from his position next to the kiosk body 100. At the same time, a second user standing at the rear side 2 may selectively rotate wheels 7 and 8.

Each of the wheels 5-8 may be rotated by grasping any one of tabs 40 that project from wheel adapters 50 that are situated along the wheels 5-8. The user may only view products mounted on adapters 50 that are not exposed, and perhaps as the second user rotates those wheels 5-8.

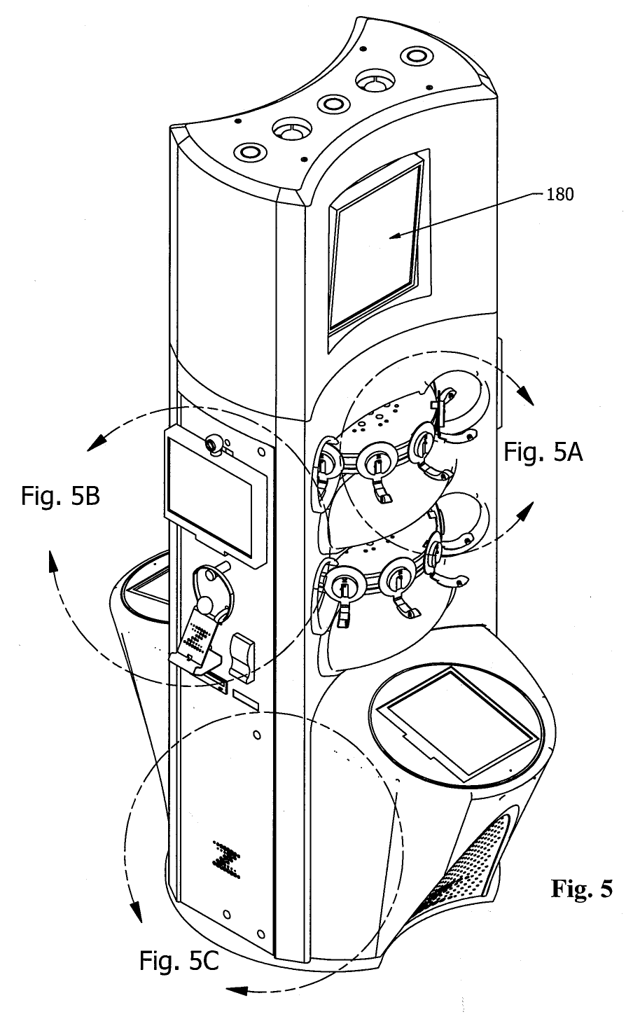

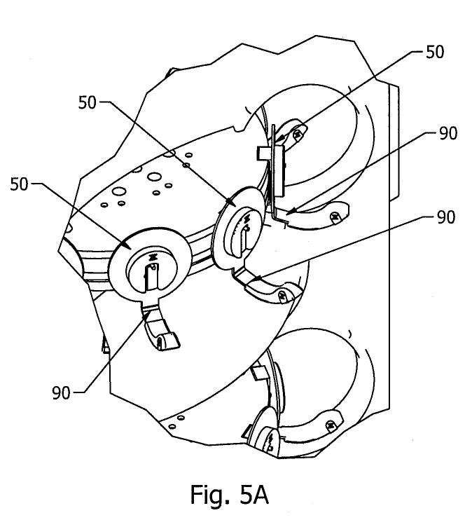

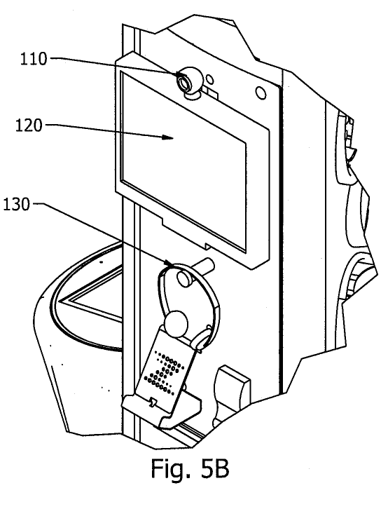

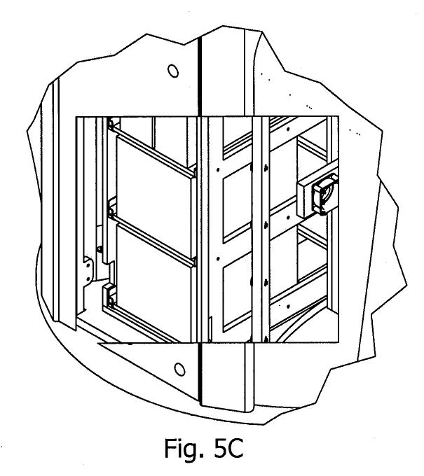

As illustrated in FIG. 5A, the wheel adapter 50 has a platform 90 to place an electronic device (not illustrated), which may be secured by a “recoiler” security device, such as a magnetic recoiler, that powers the electronic device and allows limited removal of the electronic device from the platform by the user for a predetermined distance, such as but not limited to 3 feet. Upon release of the electronic device, the recoiler pulls the electronic device back to the platform. Unauthorized removal of the product will trigger a security system and alert store personnel.

The wheel adapter 50 may be removed from the wheels 5-8 and arranged in number and/or as space permits as desired by the user. In the preferred embodiment, there are 10 adapters 50 per each of the wheels 5-8 that are evenly spaced from each other.

The kiosk body 100 has user stations on each of the left and right sides 3 and 4, each with a web camera 110, a display screen 120, headphones 130 and a keyboard that may be a physical keyboard or a virtual keyboard on a touch screen. The keyboard corresponds with and may be displayed on the display screen 120 to allow the user to enter user information to establish a shopping cart. It is foreseen that the display screen 120 may be a touch screen.

Information inputted by the user may include but is not limited to name, address, billing information, and other background information that may be necessary to tailor the shopping cart to the user's security information such as user name and password, desired goods, marketing preferences, shopping preferences, and/or personal preferences such as colors, layouts, etc.

The shopping cart information is saved and is communicable to an unlimited number of kiosks to allow the user to continue shopping. The shopping cart information is lastly communicated to a point of sale device for collection of the electronic devices and to process payment therefore.

The kiosk body 100 may also contain credit card processor which may be used for such functions as but not limited to product purchase and adding or subtracting credits to the shopping cart or other credit/token tool. The credit card processing may be accomplished by the customer and/or the sales associate. There is a programming keyboard to allow the customer and/or the sales associate to program the kiosk with respect to setting lighting, controlling electronic product information

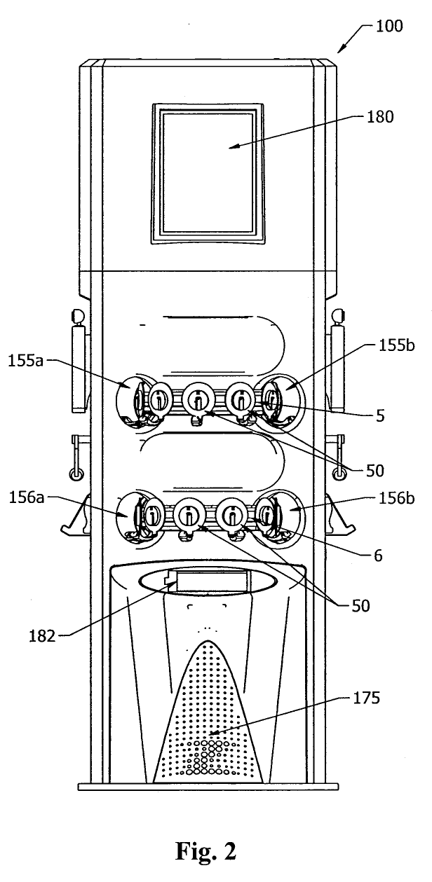

The kiosk 100 is equipped with lights to enhance the user's experience. The lights can be contained within tunnels 155a, 155b, 156a, and 156b located on either end of the wheels 5 and 6, as illustrated in FIG. 2. Although the tunnels 155a, 155b, 156a, and 156b may contain any number of lights, the preferred embodiment contains 2 lights per tunnel 155a, 155b, 156a, and 156b. While the tunnels 155a, 155b, 156a, and 156b are illustrated as circular, the tunnels 155a, 155b, 156a, and 156b may be any shape that is sufficient to permit the electronic devices on the wheels 5-8 to enter the tunnels 155a, 155b, 156a, and 156b.

Lights may also be contained behind a grate 175 at the lower portion of the kiosk body 100 to enhance the user experience.

The kiosk 100 may also contain credit card processing and/or the credit card or money intake may be accomplished by the customer and/or the sales associate.

The present general inventive concept is equipped with a programming keyboard to allow a customer and/or a sales associate to program the present general inventive concept with respect to setting lighting as well as inputting and controlling electronic product information.

The kiosk body 100 has upper product displays 180 and 181 located at an upper portion of the kiosk body 100 and lower product displays 182 and 183 located at a lower portion of the kiosk body 100. The lower product displays 182 and 183 are touch screen displays that allow the user to control the present general inventive concept. Specifically, the user may select products for more information or comparison with other products.

Upper product displays 180 and 181 display information over the users head to allow others to view information. The upper product displays 180 and 181 may display information that is being displayed on lower product display 182 and 183, but without the touch screen controls or buttons of the lower product display 182 and 183.

All product displays 180-183 display the product that is oriented in a center position on the wheels 5-8 and centered in front of the user. The displays product displays 180-183 may display two different products at which point the user may rotate either or both of the wheels 5-8 to view different products or select one of the products being displayed for more information and/or adding the product to the shopping cart.

The present general inventive concept is cooled by in-taking air via the grate 175, as illustrated in FIG. 2. Air enters the kiosk body 100, travels upward, and exits the kiosk body 100 via output ports 176 and 177. Although any number of fans may be used, air is circulated through the kiosk body 100 by first and second internal blow fans 178 and 179 that are located inside the kiosk body 100 and adjacent to the output ports 176 and 177.

The output ports 176 and 177 are located on either side of a center light 215 and in between a left light 216 and a right light 217. The output ports 176 and 177 may also have lights projecting therefrom to enhance the user experience. While any number of lights may be contained behind the grate 175, the preferred embodiment contains 3 lights (not illustrated).

A user experience may be as follows. The user desires to purchase a cellular phone and enters a cellular phone retail store having six kiosk bodies 100 according to the present general inventive concept. The user approaches the front side 1 of kiosk body 100 to view cellular phones contained therein. The user rotates either or both of the wheels 5 and 6 independent of each other, although it is foreseen that the wheels may be designed to move dependent to each other, to view the selection of cellular phones.

As the wheels 5 and 6 are rotating, the display screens 180 and 182 display an animated version of the physical cellular phones contained on each of the wheel adapters 90 as each of the wheel adapters 90 passes a position central with respect to the kiosk body 100. In other words, one of the wheel adapters 90 is in the central position when an equal portion of the wheel 5-8 is exposed on either side of the adapter 90.

The user may select the animated version of the cellular phone for more information or to compare the cellular phone with any other phone the user may find of interest. The user may also add the phone to a shopping cart. The user may also view related accessories, find out more information about accessories, and add a complete package including those accessories for final purchase upon check out at a P.O.S. (point of sale) apparatus.

While the wheel is being rotated, a color and/or temperature of the light may change to correspond with the phone in the center position. When the wheels 5-8 stops, the light may hold its current color. Light of the same color and/or temperature may be activated in another location to correspond with the light being emitted while the wheels 5-8 are rotated. The other location may be another kiosk body 100 to indicate to the user as to the location of accessories for the cellular phone. For example, lighting may change from white to a primary color such as from red to light red to pink. Any of the lights mentioned herein may use any one of the lighting schemes contained herein to provide uniform lighting. Lighting is intended to provide a feeling of liveliness and otherwise provide an intelligent, interactive user experience.

After adding the phone to the shopping cart, the user may then proceed to the kiosk with accessories for the phone.

Anytime before, during, or after, the user may enter shopping cart information and/or add credits to the shopping cart via credit card and a credit card processing/swipe apparatus. Such information may be added by stepping to the left or right sides 3 and 4 of the kiosk body 100 and utilizing the keyboard and corresponding display 120.

The left and/or right sides 3 and 4 may also have headphones 130 to allow the user to listen to and/or download contents, such as but not limited to MP3s, videos, movies, television shows, games, and/or other like audio and/or visual media. The present general inventive concept may also be equipped with an IPOD docking station, Bluetooth, and DVD-R for music and video downloads and/or uploads.

The present general inventive concept may interact with up to four customers at a time, one on all four sides 1-4 of the kiosk body 100. Any number of users may view the upper displays 180 while the present general inventive concept is in use.

Virtual tracking of one or more of the wheels 5-8 is accomplished by sensors (not illustrated). While any number of sensors may be used to provide increased precision. The preferred embodiment has one sensor per each of the wheels 5-8 to track movement thereof. As such, the wheels 5-8 are calibrated after no more than a full, 360 degree rotation and recalibrated after each 360 degree rotation. Further, upon turning the power off and on to the present general inventive concept, the wheels 5-8 may require calibration although a memory may be used to retain calibration information.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An apparatus to display a plurality of products thereon, the apparatus comprising:
a body having a user interface;
a rotatable element that extends through the body to support a product thereon;
a display that corresponds to the rotatable element; and
an input screen to allow a user to select the product.

2. A system to enable a user to view and purchase at least one of a plurality of products, the system comprising:
providing a unit having a user interface and a rotatable element supporting a plurality of products thereon;
displaying a virtual image of at least one of the plurality of products on a display element; and
permitting selection of at least one of the plurality of products via an input element to gain more information on the product; and
permitting purchase of at least one of the plurality of products via the input element.

3. The system according to claim 2, wherein the virtual image of one of the plurality of products is displayed based on an orientation of the rotatable element.

4. The system according to claim 2, wherein the rotatable element extends through the body and is exposed on at least two sides thereof.
